(19) United States
(12) Patent Application Publication
(10) Pub. No.: US 2002/0076504 A1
(43) Pub. Date: Jun. 20, 2002

(54) Photoactivatable coating composition and its use for the preparation of coatings with a rapidly processable surface at ambient temperature

(76) Inventors: Huig Klinkenberg, Katwijk aan Zee (NL); Arie Noomen, Voorhout (NL)

Correspondence Address: Joan M. McGillycuddy, Akzo Nobel Inc., Intellectual Property Department, 7 Livingstone Avenue, Dobbs Ferry, NY, 10522-3408, US

(21) Appl. No.: 09/820,074

(22) Filed: Mar. 28, 2001

(30) Foreign Application Priority Data
Mar. 28, 2000 (EP) 00201102.1
Jun. 6, 2000 (EP) 00201968.5

(51) Int. Cl. C08F 2/48

(52) U.S. Cl. 427/508; 522/7

(57) ABSTRACT

Photoactivatable coating composition comprising (A) an activated unsaturated group-containing compound, (B) an activated CH group-containing compound such as an oligomeric or polymeric malonate compound and/or an acetoacetate group-containing compound, (C) a catalyst in the form of one or more Lewis or Brönstedt bases, with the conjugated acids of the latter having a pKa of at least 10, such as 1,8-diazabicyclo[5.4.0]undec-7-ene, and (D) a photoinitiator, wherein the photoinitiator is a photolatent base. Preference is given to a coating composition wherein the photolatent base is an α-aminoalkene of the structure

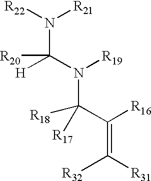

wherein R₁₆ is phenyl ; R₁₇ and R₁₈ are hydrogen or methyl; R₁₉ and R₂₁ together form a C₃-alkylene bridge; R₂₀ and R₂₂ together form a C₃-alkylene bridge; R₃₁ and R₃₂ are hydrogen.

The composition may additionally comprise a sensitizer selected from the group of thioxanthones, oxazines, rhodamines, ketocoumarins, and preferably from the group of benzophenone and derivatives thereof.

This application claims priority of European Application No. 00201102.1, filed on Mar. 28, 2000, and European Application No. 00201968.5, filed on Jun. 6, 2000.

### BACKGROUND OF THE INVENTION

A photoactivatable coating composition is known from, int. al., EP-A-0 582 188. The coating layers produced with the coating compositions disclosed therein can be cured first by UV radiation and then, thoroughly, in a conventional manner at ambient temperature and/or by heating. A key drawback of the known coating compositions is the simultaneous presence of at least two entirely different curing mechanisms. One mechanism is based on the reaction between CH-acid compounds and olefinically unsaturated compounds, which is preferably carried out in the presence of a base, whereas the other mechanism requires UV radiation for curing a radiation-curable oligomer with at least two (meth)acrylate groups. The latter mechanism can present serious problems in places which are not readily accessible to UV light, such as three-dimensional surfaces, or where the presence of pigments does not allow the UV radiation to penetrate into lower layers.

Furthermore, an effect of the so-called double cure system is that to still achieve a minimum degree of curing in places unexposed to UV light where the curing only takes place in part, use will have to be made of compounds having a higher functionality. Using such compounds has a viscosity increasing effect, which leads to a greater quantity of solvent being required to achieve a similar spraying viscosity, which in turn is attended with an increase in the VOC.

The invention now provides coating compositions which can be cured by UV radiation without any problems occurring when the UV light cannot reach all parts of the curable coating layer. The invention also provides coating compositions wherein the compounds A and B are cured with the same curing mechanism in the presence or absence of UV light. Finally, the invention provides coating compositions having a low VOC.

### SUMMARY OF THE INVENTION

The invention relates to a photoactivatable coating composition comprising (A) an activated unsaturated group-containing compound, (B) an activated CH group-containing compound, (C) a catalyst in the form of one or more Lewis or Brönstedt bases, with the conjugated acids of the latter having a pKa of at least 10, and (D) a photoinitiator, and to its use for the preparation of coatings with a rapidly processable surface at ambient temperature.

### DETAILED DESCRIPTION OF THE INVENTION

The photoactivatable coating composition according to the invention is characterized in that the photoinitiator is a photolatent base. Examples of suitable photolatent bases (D) are

1) α-ammonium, α-iminium or α-amidinium salts of formula (I) or (II) I),

wherein

m is 1 or 2 and corresponds to the number of positive charges of the cation;

R₁ is phenyl, naphthyl, phenanthryl, anthracyl, pyrenyl, thienyl, thianthrenyl, thioxanthyl, fluorenyl or phenoxazinyl, these radicals being unsubstituted or mono- or polysubstituted with C₁-C₁₈ alkyl, C₃-C₁₈ alkenyl, NR₆R₇, OH, CN, OR₈, SR₈, C(O)R₉, C(O)OR₁₀ or halogen, or R₁ is a radical of formula A

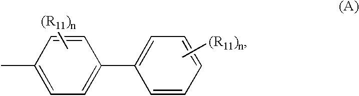

R₂, R₃ and R₄ each independently are hydrogen, C₁-C₁₈ alkyl, C₃-C₁₈ alkenyl or phenyl, or R₂ and R₃ and/or R₄ and R₃ each independently form a C₂-C₁₂ alkylene bridge; or R₂, R₃, R₄, together with the linking nitrogen atom, are a group of the structural formula (a), (b), (c), or (d)

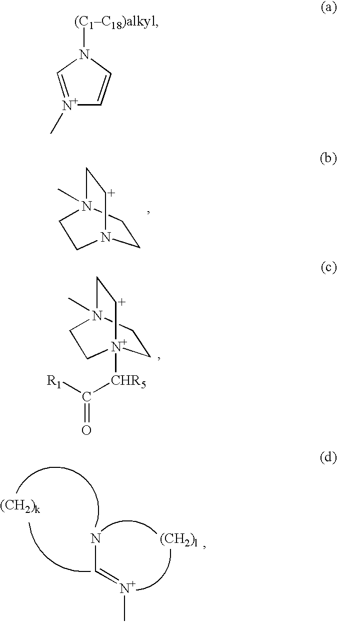

k and l each independently are a number from 2 to 4;

R₅, R₆, R₇, R₈, R₉, and R₁₀ are hydrogen or C₁-C₁₈ alkyl;

R₁₁ is C₁-C₁₈ alkyl, C₂-C₁₈ alkenyl, NR₆R₇, OR₈, or SR₈; and

n is 0 or 1, 2 or 3;

R₁₂, R₁₃ and R₁₄ are phenyl or another aromatic hydrocarbon, these radicals being unsubstituted or mono- or polysubstituted with C₁-C₁₈ alkyl, OR₈ or halogen;

R₁₅ is C₁-C₁₈ alkyl, phenyl or another aromatic hydrocarbon, the radicals phenyl and aromatic hydrocarbon being unsubstituted or mono- or polysubstituted with C₁-C₁₈ alkyl, OR₈ or halogen.

Other examples of suitable photolatent bases (D) are

2) Compounds of formula (III) or (IV)

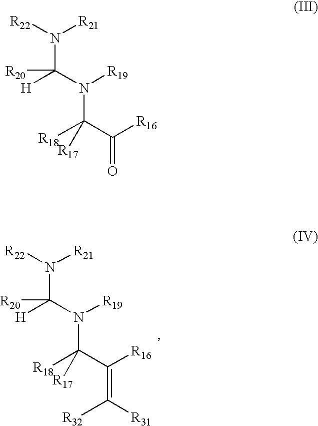

wherein

R₁₆ is phenyl, naphthyl, phenanthryl, anthracyl, pyrenyl, thienyl, thianthrenyl, thioxanthyl, fluorenyl or phenoxazinyl, these radicals being unsubstituted or mono- or polysubstituted with C₁-C₁₈ alkyl, C₃-C₁₈ alkenyl, NR₂₃R₂₄, OH, CN, OR₂₅, SR₂₅, C(O)R₂₆, C(O)OR₂₇ or halogen, or R₁₆ is a radical of formula A

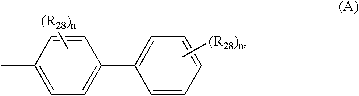

R₁₇ and R₁₈ each independently are hydrogen, C₁-C₁₈ alkyl, C₃-C₁₈ alkenyl, C₃-C₁₈ alkynyl or phenyl;

R₂₀ is C₁-C₁₈ alkyl or NR₂₉R₃₀;

R₁₉, R₂₁, R₂₂, R₂₃, R₂₄, R₂₅, R₂₆, and R₂₇ are hydrogen or C₁-C₁₈ alkyl;

R₂₈ is C₁-C₁₈ alkyl, C₂-C₁₈ alkenyl, NR₂₃R₂₄, OR₂₅, or SR₂₅; and R₂₉ and R₃₀ each independently are hydrogen or C₁-C₁₈ alkyl; or

R₁₉ and R₂₁ together form a C₂-C₁₂ alkylene bridge or

R₂₀ and R₂₂ together, independently of R₁₉ and R₂₁, form a C₂-C₁₂ alkylene bridge or, if R₂₀ is NR₂₉R₃₀, R₃₀ and R₂₂ together form a C₂-C₁₂ alkylene bridge.

R₃₁ is hydrogen or C₁-C₁₈ alkyl;

R₃₂ is hydrogen, C₁-C₁₈ alkyl or phenyl substituted with C₁-C₁₈ alkyl.

Preferred compounds are α-ammonium, α-iminium or α-amidinium salts of formula (I) or (II) wherein

m is 1

R₁ is phenyl or naphthyl, these radicals being unsubstituted or mono- or poly-substituted with C₁-C₆ alkyl, OR₈ or SR₈,

R₂, R₃ and R₄ each independently are hydrogen, C₁-C₁₈ alkyl, or phenyl, or R₂ and R₃ and/or R₄ and R₃ each independently form a C₂-C₆ alkylene bridge; or

R₂, R₃, R₄, together with the linking nitrogen atom, are a group of the structural formula (d),

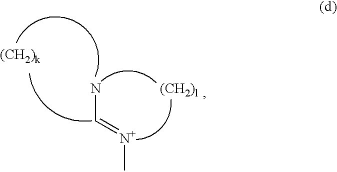

k and l each independently are a number from 2 to 4;

R₅ and R₈ are hydrogen or C₁-C₆ alkyl;

R₁₂, R₁₃, R₁₄, and R₁₅ are phenyl or another aromatic hydrocarbon, these radicals being unsubstituted or mono- or polysubstituted with C₁-C₆ alkyl or halogen, and

compounds of formula (III) or (IV)

wherein

R₁₆ is phenyl, or naphthyl, these radicals being unsubstituted or mono- or polysubstituted with C₁-C₆ alkyl, OR₂₅, SR₂₅,

R₁₇ and R₁₈ are hydrogen or C₁-C₆ alkyl;

R₁₉ and R₂₁ together form a C₂-C₆ alkylene bridge;

R₂₀ and R₂₂ together form a C₂-C₆ alkylene bridge;

R₂₅ is hydrogen or C₁-C₆ alkyl

R₃₁ and R₃₂ are hydrogen.

Thus far optimum results have been obtained using the compounds of formula (IV), wherein

R₁₆ is phenyl;

R₁₇ and R₁₈ are hydrogen or methyl;

R₁₉ and R₂₁ together form a C₃-alkylene bridge;

R₂₀ and R₂₂ together form a C₃-alkylene bridge;

R₃₁ and R₃₂ are hydrogen.

Preference is given to a composition where the photolatent base (component (D)) is present in an amount from 0.01 to 10, and preferably 0.2 to 5, wt. % based on components (A)+(B).

Optimum results for the curing reaction of the unexposed parts have been obtained with a catalyst (C) in an amount from 0.01 to 10, preferably 0.2 to 3, wt. % based on components (A)+(B). Also preferred is (C) and (D) being present in an amount such that the weight ratio of (C) to (D) is in the range of 0.1 to 2.5, most preferably 0.2 to 1.5.

The coating compositions according to the invention are radiation curable after application and, optionally, evaporation of solvents. In particular, they are suitable for curing by irradiation with UV radiation. Combinations of IR/UV irradiation are also suitable. Radiation sources which may be used are those customary for UV, such as high- and medium-pressure mercury lamps.

In order to avoid any risk involved in handling UV light of very short wavelength (UV-B and/or UV-C light) preference is given to fluorescent lamps which produce the less injurious UV-A light, especially for use in automotive refinishing shops. However, the intensity of the light produced by said lamps is too low to overcome oxygen inhibition of radically curing systems. Hence UV curing of coating compositions such as proposed in EP-A-0 582 188 does not perform efficiently.

Surprisingly, it has now been found that when a photolatent base is used as the photoinitiator, more particularly when a sensitiser is also employed, there are no problems as a result of oxygen inhibition during irradiation with UV light from fluorescent lamps.

Suitable sensitisers are all compounds known to those skilled in the art as sensitisers. Examples are e.g. thioxanthones, such as isopropyl thioxanthone, ketocoumarines, oxazines, rhodamines, benzophenone, and derivatives thereof.

Surprisingly, it has been found that colourless surfaces can be obtained with benzophenone and derivatives thereof.

Examples of suitable derivatives of benzophenone are:

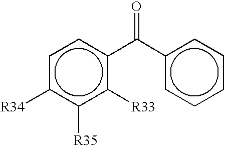

wherein R₃₃, R₃₄, and R₃₅ may be the same or different and stand for CH₃ or H (e.g. Speedcure BEM® ex Lambson),

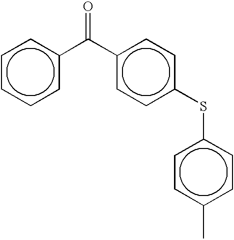

(e.g. Quantacure BMS® ex G. Lakes), and

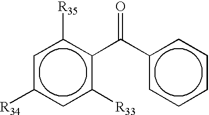

wherein R₃₃, R₃₄, and R₃₅ may be the same or different and stand for CH₃ or H (e.g. Esacure TZT® ex Lamberti).

The sensitiser may be present in amount of 0.1 to 5 wt % on solid resins.

For compound (C) optimum results have been found thus far with both electrically neutral and electrically charged bases.

Suitable catalysts include electrically neutral bases such as amines and derivatives thereof. It is preferred that use be made of a base of which the conjugated acid has a pKa of at least 12, such as amines of the amidine type, examples of which include tetramethyl guanidine, 1,8-diazabicyclo-[5,4,0]-undec-7-ene (DBU), and 1,5-diazabicyclo-[4.3.0]-non-5-ene (DBN). Thus far, optimum results have been obtained with DBU.

According to the invention, electrically charged bases also constitute suitable catalysts, provided that the conjugated acid thereof has a pKa>10, preferably >12. As examples of representative bases may be mentioned metal bases and quaternary ammonium bases. Examples of suitable bases include metal alcoholates such as sodium methanolate or sodium phenolate; metal hydroxides such as sodium hydroxide; metal hydrocarbon compounds such as n-butyl lithium; metal hydrides such as sodium hydride; metal amides such as potassium amide; metal carbonates such as potassium carbonate; quaternary ammonium hydroxides such as tetrabutyl ammonium hydroxide; quaternary ammonium alkoxides such as benzyltrimethyl ammonium methoxide, and quaternary ammonium carbanions such as benzyltrimethyl ammonium acetyl acetate.

Suitable activated unsaturated group-containing compounds generally are ethylenically unsaturated compounds in which the carbon-carbon double bond is activated by a carbonyl group in the α-position. As representative examples may be mentioned such compounds as disclosed in U.S. Pat. No. 2,759,913 (see especially col. 6, line 35 through col. 7, line 45), U.S. Pat. No. 4,871,822 (see especially col. 2, line 14 through col. 4, line 14), U.S. Pat. No. 4,602,061 (see especially col. 3, line 14 through col. 4, line 14), and EP-A-0448154 (see especially page 2, line 53 through page 3, line 28).

Suitable examples are the (meth)acrylic esters of compounds containing 1-6 hydroxyl groups and 1-20 carbon atoms. Instead of or in addition to (meth)acrylic acid there may be used, for example, crotonic acid and cinnamic acid. These esters may optionally contain hydroxyl groups. Especially preferred examples include hexanediol diacrylate, trimethylolpropane triacrylate, and pentaerythritol tetraacrylate.

Other examples are polyesters based upon the reaction product of maleic, fumaric and/or itaconic acid (and maleic and itaconic anhydride) and di- or polyvalent hydroxyl compounds, optionally including a monovalent hydroxyl and/or carboxyl compound.

Further suitable activated unsaturated group-containing compounds are polyester and/or alkyd resins containing pendant activated unsaturated groups. Preference is given to urethane (meth)acrylates obtained by reaction of a polyisocyanate with a hydroxyl group-containing (meth)acrylic ester, e.g., a hydroxyalkyl ester of (meth)acrylic acid or a compound prepared by esterification of a polyhydroxyl compound with a less than stoichiometric amount of (meth)acrylic acid; polyether (meth)acrylates obtained by esterification of a hydroxyl group-containing polyether with (meth)acrylic acid; polyfunctional (meth)acrylates obtained by reaction of a hydroxyalkyl (meth)acrylate with a polycarboxylic acid and/or a polyamino resin; poly(meth)acrylates obtained by reaction of (meth)acrylic acid with an epoxy resin, and polyalkyl maleates obtained by reaction of a monoalkyl maleate ester with an epoxy resin and/or a hydroxy-functional oligomer or polymer.

Especially preferred among the activated unsaturated group-containing compounds are the urethane (meth)acrylates obtained by reaction of a polyisocyanate with a hydroxyl group-containing (meth)acrylic ester. Examples of suitable polyisocyanates include hexamethylene diisocyanate, the trimer of hexamethylene diisocyanate isophorone diisocyanate, and the trimer of isophorone diisocyanate. Examples of suitable hydroxyl group-containing (meth)acrylic esters include 2-hydroxypropyl (meth)acrylate and 4-hydroxybutyl (meth)acrylate. Most preferred is the urethane acrylate based on the trimer of isophorone diisocyanate and 4-hydroxybutyl acrylate.

Also, preference is given to coating compositions where the acid value of the activated unsaturated group-containing compounds is about 2 or less, the Mn is between about 500 and about 1,500, and the functionality is at least 2.

Suitable activated CH group-containing compounds generally are compounds containing a methylene and/or monosubstituted methylene group in the α-position to two carbonyl groups, such as malonate and/or acetoacetate group-containing compounds.

Examples of malonate group-containing compounds are disclosed in U.S. Pat. No. 2,759,913 (see especially col. 8, lines 51-52), and malonate group-containing oligomeric and polymeric compounds are disclosed in U.S. Pat. No. 4,602,061 (see especially col. 1, line 10 through col. 2, line 13). Preferred compounds are the oligomeric and/or polymeric malonate group-containing compounds, such as polyurethanes, polyesters, polyacrylates, epoxy resins, polyamides, and polyvinyl resins, which contain malonate groups in the main chain or are pendant or both.

Malonate group-containing polyurethanes can be obtained, for example, by reacting a polyisocyanate with a hydroxyl group-containing ester of a polyol and malonic acid, or by esterification or transesterification of a hydroxy-functional polyurethane with malonic acid or a dialkylmalonate.

Malonate group-containing polyesters can be obtained, for example, by the polycondensation of malonic acid, an alkyl malonic acid (such as ethyl malonic acid), a mono- or dialkyl ester of such a malonic acid and/or the reaction product of a malonic ester and an alkyl (meth)acrylate, optionally with other di- or polycarboxylic acids, with di- and/or higher-functional hydroxy compounds, and, optionally, monofunctional hydroxy and/or carboxyl compounds. Preferred is the polycondensation product of a dialkyl ester of malonic acid and a di- and higher-functional hydroxy compound. Examples of suitable dialkyl esters of malonic ester include dimethyl malonate and diethyl malonate. Examples of suitable di- and higher-functional hydroxy compounds include ethane diol, 1,3-propanediol, 1,2-propanediol, 2-methyl-1,3-propanediol, 1,4-butanediol, 1,3-butanediol, 1,6-hexanediol, neopentylglycol, glycerol, pentaerythritol, trimethylol propane, ditrimethylol propane, 1,4-cyclohexane dimethanol, the monoester of neopentylglycol and hydroxy pivalic acid, 2,2,4-trimethyl pentanediol, dimethylol propionic acid, and 1,5-pentanediol. Most preferred is the polycondensation product of diethyl malonate and 1,5-pentanediol.

Malonate group-containing epoxy esters can be obtained, for example, by esterifying an epoxy resin with malonic acid or a malonic monoester, or by transesterification with a dialkyl malonate, optionally with other carboxylic acids and derivatives thereof.

Malonate group-containing polyamides can be obtained, for example, in the same manner as the polyesters, in which case at least part of the hydroxy compound is replaced with a mono- and/or polyvalent primary and/or secondary amine.

Other malonate group-containing polymers can be obtained by the transesterification of an excess of a dialkyl malonate with a hydroxy-functional polymer, for example, a vinyl alcohol/styrene copolymer. In this manner, a polymer with malonate group-containing side-chains may be formed. Any excess dialkyl malonate can be removed under reduced pressure or, optionally, may be used as a reactive solvent.

Use can also be made of these malonate group-containing compounds in which the malonic acid structural unit is cyclised, for example by formaldehyde, acetaldehyde, acetone or cyclohexanone.

Preference is given to malonate group-containing oligomeric esters, polyesters, polyurethanes, and epoxy esters containing 2-100, more preferably 2-20, malonate groups per molecule. In said case preference is given to compounds having a number average molecular weight (Mn) in the range of from about 250 to about 3,000, and an acid number of about 2 or less.

As examples of acetoacetate group-containing compounds may be mentioned acetoacetic esters as disclosed in U.S. Pat. No. 2,759,913 (see especially col. 8, lines 53-54), diacetoacetate compounds as disclosed in U.S. Pat. No. 4,217,396 (see especially col.2, line 65 through col. 3, line 27), and acetoacetate group-containing oligomeric and polymeric compounds as disclosed in U.S. Pat. No. 4,408,018 (see especially col.1, line 51 through col. 2, line 6). Preference is given to the oligomeric and/or polymeric acetoacetate group-containing compounds, such as polyurethanes, polyesters, polyacrylates, epoxy resins, polyamides, and polyvinyl resins, which contain acetoacetate groups in the main chain or are pendant or both.

Suitable acetoacetate group-containing oligomeric and polymeric compounds can be obtained, for example, from polyalcohols and/or hydroxy-functional polyether, polyester, polyacrylate, vinyl and epoxy oligomers and polymers by reaction with diketene or transesterification with an alkyl acetoacetate. Such compounds can also be obtained by the copolymerisation of an acetoacetate-functional acrylic monomer with other vinyl- and/or acrylic-functional monomers.

Especially preferred among the acetoacetate group-containing compounds for use with the present invention are acetoacetate group-containing oligomers and polymers containing at least two acetoacetate groups. It is also especially preferred that such acetoacetate group-containing compounds have an Mn in the range of from about 234 to about 30,000, and an acid number of about 2 or less.

Compounds containing both malonate and acetoacetate groups in the same molecule are also suitable and can be obtained, for example, by a Michael reaction between a malonate-functional polyester and an acetoacetate-functional acrylic compound (e.g., acetoacetoxyethyl acrylate). Additionally, physical mixtures of malonate and acetoacetate group-containing compounds are suitable. Alkylacetoacetates can, in addition, be used as reactive diluents.

Optionally, the activated CH groups-containing compounds may be utilised in the enamine form, such as disclosed in EP-A-0 420 133.

Components (A) and (B) react with each other through a Michael addition, in which the activated CH group of component (B) adds to one of the carbon atoms of the activated unsaturated group of component (A). Components (A) and (B) preferably are present in the coating compositions in an amount such that the ratio of the number of activated CH groups to the number of activated unsaturated groups is in the range of about 0.25 to about 4.0, more preferably in the range of about 0.5 to about 2.0.

The use of α-amino alkenes as photolatent base in coating compositions containing both activated unsaturated group-containing compounds and activated CH group-containing compounds has been disclosed in WO 98/41524 (see especially pages 1, 14, and 36-37). However, not the slightest allusion is made therein to the combined use of a photolatent base and an unblocked base.

The coating composition of the present invention may be applied to any substrate. The substrate may be, for example, metal, plastic, wood, glass, ceramic, or another coating layer. The other coating layer may be comprised of the coating composition of the current invention or it may be a different coating composition. The coating compositions of the current invention show particular utility as clear coats, base coats, pigmented top coats, primers, and fillers. The coating compositions can be applied by conventional means such as by spray gun, brush, or roller, spraying being preferred. Curing temperatures are preferably between 0 and 80° C., and more preferably between 20 and 60° C. The compositions are particularly suitable in the preparation of coated metal substrates, such as in the refinish industry, in particular the body shop, to repair automobiles and transportation vehicles, and in finishing large transportation vehicles such as trains, trucks, buses, and aeroplanes.

Preferred is the use of the coating composition of the present invention as clear coat. Clear coats are required to be highly transparent and must adhere well to the base coat layer. It is further required that the clear coat does not change the aesthetic aspect of the base coat by strike-in, i.e. discolouration of the base coat due to its solvation by the clear coat composition, or by yellowing of the clear coat upon outdoor exposure. A clear coat based on the coating composition of the present invention does not have these drawbacks.

In the case of the coating composition being a clear coat, the base coat may be a conventional base coat known in the coating art. Examples are solvent borne base coats, e.g., Autobase® ex Sikkens, based on cellulose acetobutyrate, acrylic resins, and melamine resins, and water borne base coats, e.g., Autowave® ex Sikkens, based on an acrylic resin dispersion and polyester resin. Furthermore, the base coat may comprise pigments (colour pigments, metallics and/or pearls), wax, solvents, flow additives, neutralising agent, and defoamers. Also high solids base coats can be used. These are, for instance, based on polyols, imines, and isocyanates. The clear coat composition is applied to the surface of a base coat and then cured. An intermediate curing step for the base coat may be introduced.

The invention will be illustrated with reference to the following examples. Of course these examples are submitted for a better understanding of the invention only; they are not to be construed as limiting in any manner the scope thereof.

### EXAMPLES

Preparation of a Urethane Acrylate Based on the Trimer of Isophorone Diisocyanate (IPDI Trimer) and 4-hydroxybutyl Acrylate (=Activated Unsaturated Bond-containing Compound).

The reaction was carried out under a dry air atmosphere and all commercial chemicals used were employed without further purification.

3,637.0 g (10.5 moles of NCO) of the trimer of isophorone diisocyanate (Vestanat T 1890® ex Hüls), 2.6 g of dibutyltin dilaurate, 2.6 g of 2,5-di-tert.-butyl-p-cresol, and 300 g of butyl acetate were charged to a three-necked flask with condenser and dropping device. Dry air was bubbled through the reaction mixture and the temperature was slowly raised to 60° C. 1,514.0 g (10.5 moles) of 4-hydroxybutyl acrylate were added, with the temperature gradually being increased to 80° C. The temperature was kept at said value and the dropping device was flushed with butyl acetate (500 g). The reaction was monitored by titration of the remaining amount of isocyanate and was over when the isocyanate content fell below 0.2% based on the solids content. The reaction product obtained had the following physical properties:

Residual 4-hydroxybutyl acrylate: <0.28% based on solids (HPLC analysis),

Colour: Gardner<<Gardner 1,

Viscosity: 478 cPa s (23° C.),

Solids content: 72.8% (1 hour at 140° C.),

GPC data (polystyrene standard): Mn 1,507, Mw 1,814, d=1.2.

Equivalent weight=527 g/eq

Acid value=1.5

Preparation of Activated CH Group-containing Compound.

The reaction was carried out under a nitrogen atmosphere and all commercial chemicals used were employed without further purification.

In a reaction vessel with stirrer and condenser 1,045 g of 1,5-pentanediol, 1,377.4 g of diethyl malonate, and 242.1 g of xylene were carefully refluxed. The maximum temperature of the reaction mixture was 196° C. while the temperature at the head of the condenser was held at 79° C. In this way 862 g of ethanol, corresponding to a conversion of 97.7%, were distilled off. Then xylene was stripped off in vacuo at a temperature of 200° C. The resulting polymer had a solids content of 98.6%, a viscosity of 2,710 mPa s, and an acid number of 0.3 mg of KOH/g based on the solids content.

Mₙ=1,838, M_{w}=3,186, colour 175 on the APHA scale (“Hazen colour number”-ISO 6271 of the American Health Association), functionality=6.

Equivalent weight=190 g/eq

Curing with UV light

The photolatent base of the formula

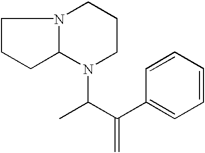

the sensitiser Quantacure BMS®, and the uncapped base 1,8-diaza-bicyclo[5,4,0]undec-7-ene (DBU) were dissolved in a mixture of the above-described urethane acrylate and the malonate polyester at an equivalent ratio of 1.3:1, such that the weight percentage of the latent base was 2.5% (based on solid resin) and that of Quantacure BMS® 0.5% (based on solid resin). The amount of DBU was varied from 0 to 5 wt. % based on solid resin.

A 50 μm thick film was drawn out onto a glass plate and exposed to UV-A light (fluorescent lamps, type Cleo® ex Philips) at a distance of 20 cm. The results of the experiments carried out at ambient temperature both in the dark and after 10 minutes' exposure are given in Table 1. The percentages quoted in the examples denote percentages by weight, and parts are parts by weight.

The times mentioned in the columns under “drying” correspond to the time until a tack-free surface had been obtained (measured both with and without UV light).

The times mentioned in the last column under “pot life” correspond to the time elapsed until the viscosity had doubled (measured in darkness).

TABLE 1

| | % DBU | % latent | % | | | | | | |
|---|---|---|---|---|---|---|---|---|---|
| | on solid | base on | Quantacure | drying after | | drying in | | | |
| Ex | resin | solid resin | on solid resin | exposure | | darkness | | pot life | |
| A | 0 | 0 | 0 | >1 | day | >1 | day | >1 | week |
| B | 0 | 2.5 | 0.5 | 10 | minutes | >1 | day | >1 | week |
| 1 | 0.5 | 2.5 | 0.5 | 10 | minutes | >90 | min. | 6 | hours |
| 2 | 1 | 2.5 | 0.5 | 10 | minutes | 90 | minutes | 5 | hours |
| 3 | 2.5 | 2.5 | 0.5 | 10 | minutes | 55 | minutes | 2 | hours |
| 4 | 5 | 2.5 | 0.5 | 10 | minutes | 35 | minutes | 45 | minutes |

According to the results mentioned in the above table, it appears that the combined use of DBU and the latent base does not have a negative effect on drying after exposure. However, drying in darkness increases with increasing DBU concentration. Up to a percentage of about 2.5 wt % of DBU the pot life is still acceptable. A percentage of 5 wt. % is attended with a pot life of only 45 minutes. For commercial application such a short pot life may be questionable for a number of applications.

We claim:

1. A photoactivatable coating composition comprising
(A) an activated unsaturated group-containing compound, (B) an activated CH group-containing compound, (C) a catalyst in the form of one or more Lewis or Brönstedt bases, with the conjugated acids of the latter having a pKa of at least 10, and (D) a photoinitiator, wherein the photoinitiator is a photolatent base.

2. A coating composition according to claim 1, wherein the photolatent base is selected from
1) α-ammonium, α-iminium or α-amidinium salts of formula (I) or (II) 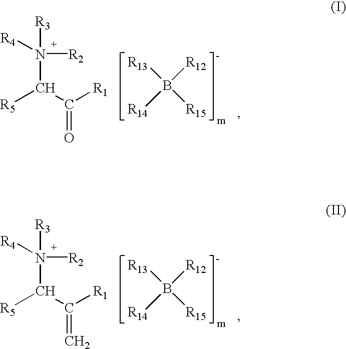
wherein
m is 1 or 2 and corresponds to the number of positive charges of the cation;
R₁ is phenyl, naphthyl, phenanthryl, anthracyl, pyrenyl, thienyl, thianthrenyl, thioxanthyl, fluorenyl or phenoxazinyl, these radicals being unsubstituted or mono- or polysubstituted with C₁-C₁₈ alkyl, C₃-C₁₈ alkenyl, NR₆R₇, OH, CN, OR₈, SR₈, C(O)R₉, C(O)OR₁₀ or halogen, or R₁ is a radical of formula A 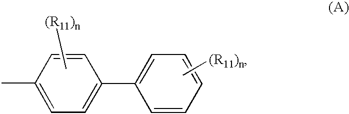
R₂, R₃, and R₄ each independently are hydrogen, C₁-C₁₈ alkyl, C₃-C₁₈ alkenyl or phenyl, or R₂ and R₃ and/or R₄ and R₃ each independently form a C₂-C₁₂ alkylene bridge; or R₂, R₃, R₄, together with the linking nitrogen atom, are a group of the structural formula (a), (b), (c), or (d) 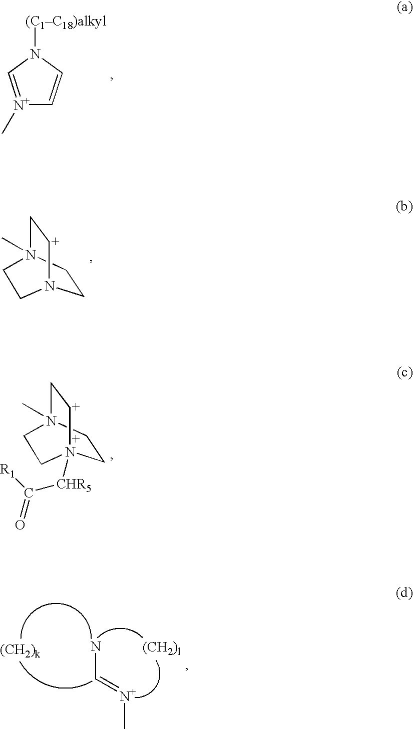
k and l each independently are a number from 2 to 4;
R₅, R₆, R₇, R₈, R₉, and R₁₀ are hydrogen or C₁-C₁₈ alkyl;
R₁₁ is C₁-C₁₈ alkyl, C₂-C₁₈ alkenyl, NR₆R₇, OR₈, or SR₈; and
n is 0 or 1, 2 or 3;
R₁₂, R₁₃, and R₁₄ are phenyl or another aromatic hydrocarbon, these radicals being unsubstituted or mono- or polysubstituted with C₁-C₁₈ alkyl, OR₈, or halogen;
R₁₅ is C₁-C₁₈ alkyl, phenyl or another aromatic hydrocarbon, the radicals phenyl and aromatic hydrocarbon being unsubstituted or mono- or polysubstituted with C₁-C₁₈ alkyl, OR₈, or halogen; or
2) compounds of formula (III) or (IV) 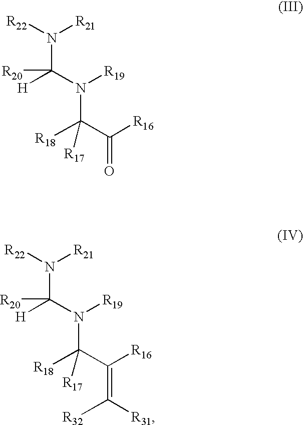
wherein
R₁₆ is phenyl, naphthyl, phenanthryl, anthracyl, pyrenyl, thienyl, thianthrenyl, thioxanthyl, fluorenyl or phenoxazinyl, these radicals being unsubstituted or mono- or polysubstituted with C₁-C₁₈ alkyl, C₃-C₁₈-alkenyl, NR₂₃R₂₄, OH, CN, OR₂₅, SR₂₅, C(O)R₂₆, C(O)OR₂₇ or halogen, or R₁₆ is a radical of formula A 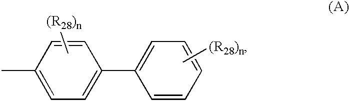
R₁₇ and R₁₈ each independently are hydrogen, C₁-C₁₈ alkyl, C₃-C₁₈ alkenyl, C₃-C₁₈ alkynyl or phenyl;
R₂₀ is C₁-C₁₈ alkyl or NR₂₉R₃₀;
R₁₉, R₂₁, R₂₂, R₂₃, R₂₄, R₂₅, R₂₆, and R₂₇ are hydrogen or C₁-C₁₈ alkyl;
R₂₈ is C₁-C₁₈ alkyl, C₂-C₁₈ alkenyl, NR₂₃R₂₄, OR₂₅, or SR₂₅; and R₂₉ and
R₃₀ each independently are hydrogen or C₁-C₁₈ alkyl; or
R₁₉ and R₂₁ together form a C₂-C₁₂ alkylene bridge or
R₂₀ and R₂₂ together, independently of R₁₉ and R₂₁, form a C₂-C₁₂ alkylene bridge or, if R₂₀ is NR₂₉R₃₀, R₃₀ and R₂₂ together form a C₂-C₁₂ alkylene bridge.
R₃₁ is hydrogen or C₁-C₁₈ alkyl;
R₃₂ is hydrogen, C₁-C₁₈ alkyl or phenyl

3. A coating composition according to claim 2, wherein the photolatent base is an α-aminoalkene of the structure (IV), 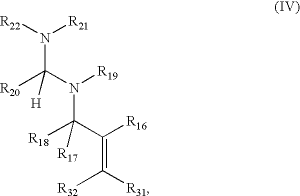
wherein
R₁₆ is phenyl;
R₁₇ and R₁₈ are hydrogen or methyl;
R₁₉ and R₂₁ together form a C₃-alkylene bridge;
R₂₀ and R₂₂ together form a C₃-alkylene bridge;
R₃₁ and R₃₂ are hydrogen.

4. A coating composition according to claim 1, wherein component (D) is present in an amount of from 0.01 to 10 wt. % based on components (A)+(B).

5. A coating composition according to claim 1, wherein component (C) is present in an amount of from 0.01 to 10 wt. % based on components (A)+(B).

6. A coating composition according to claim 1, wherein the composition additionally comprises a sensitiser selected from the group of thioxanthones, oxazines, ketocoumarins, rhodamines, benzophenone, and derivatives thereof.

7. A coating composition according to claim 6, wherein the sensitiser is selected from the group of benzophenone and derivatives thereof.

8. A coating composition according to claim 1, wherein (C) is 1,8-diazabicyclo-[5,4,0]-undec-7-ene.

9. A coating composition according to claim 1, wherein the compound with an activated CH group is an oligomeric or polymeric malonate compound and/or an acetoacetate group-containing compound.

10. A coating composition according to claim 9, wherein the malonate compound is a polyurethane, a polyester, a polyacrylate, an epoxy resin, a polyamide or a polyvinyl resin with malonate groups in the main and/or side chain.

11. A coating composition according to claim 1, wherein (A) and (B) are present in an amount such that the ratio of the number of activated CH groups to the number of activated unsaturated groups is in the range of about 0.25 to about 4.0.

12. A coating composition according to claim 11, wherein (A) and (B) are present in an amount such that the ratio of the number of activated CH groups to the number of activated unsaturated groups is in the range of about 0.5 to about 2.0.

13. A coating composition according to claim 1, wherein (C) and (D) are present in an amount such that the weight ratio of (C) to (D) is in the range of about 0.1 to about 2.5.

14. A coating composition according to claim 1 wherein the coating is applied to a substrate and subsequently the substrate is exposed to UV light.

15. Use of a coating composition according to claim 1 in car repair.
